(19) United States
(12) Patent Application Publication
(10) Pub. No.: US 2003/0036914 A1
(43) Pub. Date: Feb. 20, 2003

(54) Method and system for common contact identification using portable computing devices

(75) Inventors: Gregory P. Fitzpatrick, Keller, TX (US); Frederick Yung-Fung Wu, Greenwich, CT (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/933,284

(22) Filed: Aug. 20, 2001

(51) Int. Cl. G06F 17/60; G09G 5/00

(52) U.S. Cl. 705/1; 345/733

(57) ABSTRACT

A method for common contact identification can include receiving in a first portable computing device corresponding to a first user a local communication from a second portable computing device corresponding to a second user. The local communication can identify the second user. A non-local wireless communication from the first portable computing device identifying at least the first and the second user can be received at a central receiving station. A data store including contact information corresponding to the first user and the second user can be accessed to determine whether the first user and the second user have at least one common contact. If at least one common contact is determined, at least one subsequent non-local wireless communication can be sent to the first and second portable computing devices. The subsequent non-local wireless communication can include an identifier common to the first and second users and can correspond to the at least one common contact.

### BACKGROUND OF THE INVENTION

1. Technical Field

This invention relates generally to discovering common contacts, and more particularly, to facilitating that discovery using portable computing devices.

2. Description of the Related Art

People and businesses prefer to associate with people and businesses with which they are familiar. In the case where one who is searching for a person or business cannot find a person or business with whom the searcher is familiar, it is usually desired by the searcher to associate with one that is recommended by or at least known to someone who is also known by the searcher. This is particularly the case in the area of social or business introductions and networking. People must meet in order to build a relationship which will promote collaboration.

People are often reluctant to approach another person of interest without an introduction by a third party who has at least some knowledge of both people. Even where someone is recognized by their appearance, their identity may be unknown and uncertain, and an introduction never occurs. It is frequently the case that persons or entities that do not know one another have common contacts; however, as this fact remains unknown to either party, introductions still do not occur. In order to determine if one's friends or business acquaintances know of a person or business, the searcher must frequently call or correspond with several people in order to obtain a name of a person or business known to an acquaintance. This can be tedious, time consuming and intrusive on the time of others, such that many do not attempt to obtain such a referral.

### SUMMARY OF THE INVENTION

The invention disclosed herein provides a method and system through which a user can identify other users having common contacts. In particular, the invention enables users of portable computing devices (PCDs) to publish their identities to one another within a local area for the purpose of identifying common contacts. If common contacts exist between two or more users, each user having a common contact can be identified through a visual identifier that can be worn by participating users. The visual identifier can be common to each user having a common contact. The present invention can be used by multiple persons in a business or social context, to establish relationships with one another. A system which has been configured according to the present invention can be used to promote collaboration between parties by fostering trust when they discover one or more common contacts known and trusted by each party.

One aspect of the invention can include a method for common contact identification. The method can include receiving in a first PCD corresponding to a first user a local communication from a second PCD corresponding to a second user. The local communication can be a wireless communication, an infrared wireless communication, or a near-field intrabody communication. Regardless, the local communication can identify the second user. A non-local wireless communication from the first PCD identifying at least the first and the second user can be received at a central receiving station. Notably, the non-local communication can be a communication to a location remote from the first and second PCDs using, for example, satellite or cellular communication technology. A data store, which can include contact information corresponding to the first user and the second user can be accessed to determine whether the first user and the second user have at least one common contact. If at least one common contact is determined, at least one subsequent nonlocal wireless communication can be sent to the first and second PCDs. The communication can include an identifier common to the first and second users and can correspond to the at least one common contact. The identifier can be provided to a display unit.

The at least one subsequent non-local wireless communication further can identify the first and second users as well as the common contact. Notably, the second PCD can provide notification to the second user that another user has at least one common contact. Similarly, the first PCD can provide notification to the first user that another user has at least one common contact.

Another aspect of the invention can include a method for common contact identification using a PCD. The method can include receiving a local communication from a second PCD at a first PCD. The local communication can identify a second user corresponding to the second PCD and can be in the form of a wireless, an infrared wireless, or a near-field intrabody communication. A non-local wireless communication can be sent from the first PCD to a receiving station. Notably, the non-local wireless communication can identify the second user and a first user corresponding to the first PCD. A non-local wireless communication can be received from the receiving station. The non-local wireless communication can include a contact common to the first user and the second user and can include an identifier common to both users. The identifier can be specified to a display. The method further can include notifying the first user that another user has been identified as having a common contact. In any case, the notification can provide the identity of the second user.

Another aspect of the invention can include a method for common contact identification using a PCD. In that case, the method can include receiving in a first PCD a communication from a second PCD. The communication can be a near-field intrabody communication or a local communication such as a wireless communication or a wireless infrared communication. The communication can include contact information from the second PCD. The contact information from the second PCD can be compared to contact information within the first PCD to determine whether one or more common contacts exist. If so, notification can be provided. For example, a visual identifier can be provided to a display device or an audible sound can be played by one of the portable computing devices.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating an exemplary system for identifying persons having common contacts.

FIG. 2 is a schematic diagram illustrating another exemplary system for identifying persons having common contacts.

FIG. 3 is a schematic diagram illustrating exemplary components which can be used with embodiments of the system disclosed herein.

FIG. 4 is a schematic diagram illustrating another exemplary system for identifying persons having common contacts.

FIG. 5 is a schematic diagram illustrating another exemplary system for identifying persons having common contacts.

FIG. 6 is a flow chart illustrating an exemplary method of identifying persons having common contacts.

### DETAILED DESCRIPTION OF THE INVENTION

The invention disclosed herein provides a method and system through which a user can identify other users having common contacts. In particular, the invention enables users to publish their identities to one another for the purpose of identifying common contacts. If common contacts exist between two or more users, each user having a common contact can be identified by a visual identifier that can be worn by participating users. The visual identifier can be common to each user having a common contact. The present invention can be used by multiple persons in a business or social context, to establish relationships with one another. A system which has been configured according to the present invention can be used to promote collaboration between parties by fostering trust when they discover one or more common contacts known and trusted by each party.

More specifically, the invention allows users within a localized area to use a portable computing device (PCD) to send and receive identifying communications to one another. Accordingly, users equipped with a PCD set to receive communications can receive identifying communications from sending devices. Having received an identifying communication from one or more sending devices, or after a mutual exchange of identifying information, contact information corresponding to each user can be compared to determine whether the users have any common contacts. If so, each user can be notified. The visual identifier can be text, symbols, or any other visual identifier which can be displayed on a portable display device that can be carried or worn by each user. Based upon the common identifier, users having common contacts can mutually and visually identify one another when in visual range of one another.

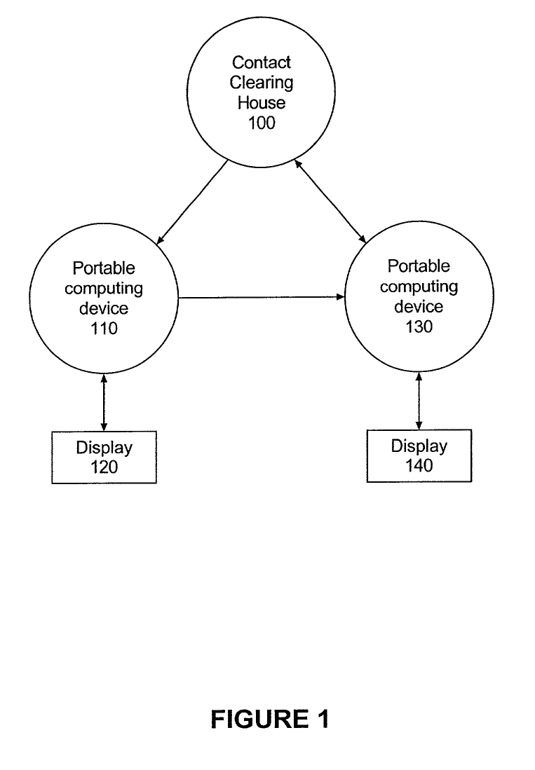

FIG. 1 is a schematic diagram illustrating an exemplary system for identifying persons having common contacts. As shown in FIG. 1, the system can include a contact clearing house 100, PCDs 110 and 130, and display units 120 and 140. The contact clearing house 100 can be located at a location remote from the PCDs 110 and 130. For example, the contact clearing house can be implemented as one or more computer programs existing within a computer system. The contact clearing house 100 can be accessed via a non-local wireless communications link such as a cellular or a satellite communications link.

The contact clearing house 100 can be operated by a trusted third party to ensure data integrity and accuracy. Operation by a third party further can decrease the likelihood of users entering false or misleading contact information in the hopes of portraying themselves in a false light to others. The contact clearing house 100 can include contact information corresponding to participating users. The contact information can be stored electronically in the form of contact lists, personal address books, buddy lists commonly associated with instant messenger clients, contact lists often used in e-mail programs, or as address books uploaded from a PCDs.

PCDs 110 and 130 can be personal digital assistants, cell phones, organizers, combinations thereof, or any other portable electronic device having the capabilities described herein when used independently or in combination with one or more add-on components. For example, a personal digital assistant when equipped with a wireless modem can be used in accordance with the inventive arrangements disclosed herein. As is known in the art, each PCD 110 and 130 can correspond to a particular user. Accordingly, such a PCD can contain an identifier which can be included within a communication originating from the PCD that can uniquely identify the user of the PCD.

As shown in FIG. 1, the PCDs 110 and 130 can communicate with the contact clearing house 100 via a non-local wireless communications link. The PCDs 110 and 130 further can communicate with one another via a local wireless communications link. For example, such PCDs commonly communicate via an infrared communication port wherein PCD 110 can be set to transmit; and, PCD 130 can be set to receive such communications.

Display units 120 and 140 can be included. The display units 120 and 140 can be any of a variety of display types such as liquid crystal displays, quartz displays, LED type displays, or other light sources capable of displaying a visual identifier. It should be appreciated that although the displays 120 and 140 are depicted as being separate from the PCDs 110 and 130, the displays 120 and 140 can be included within the PCDs 110 and 130 respectively. Accordingly, the invention is not so limited to having separate display units for displaying visual identifiers.

Display unit 120 can be communicatively linked to PCD 110; and, display unit 140 can be communicatively linked to PCD 130. In this manner, each PCD can specify a visual identifier to be displayed on each display. For example, the displays 120 and 140 can be connected to PCDs 110 and 130 through a suitable communications circuitry. Alternatively, the PCDs can communicate with the displays via a wireless connection using an infrared or radio frequency communications link. The display devices 120 and 140 can include a power source. Alternatively, if connected to the PCDs 110 and 130 through suitable electronic circuitry, the displays 120 and 140 can be powered from PCDs 110 and 130. The display units can be sized such that a user can conveniently carry the display in a position that would be viewable by another user passing by. For example, in one embodiment, the display unit can be affixed to the user's clothing or worn around the user's neck.

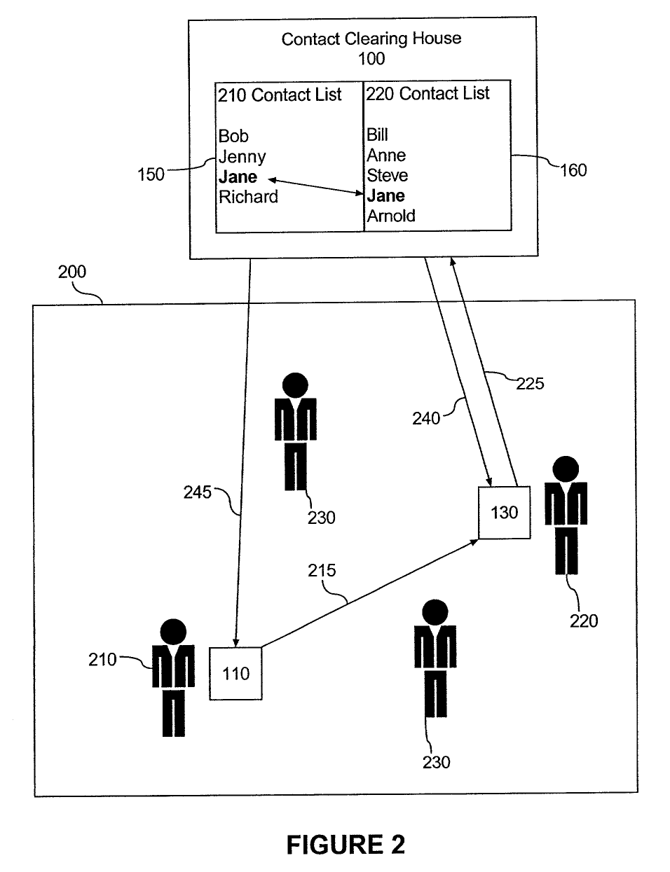

FIG. 2 is a schematic diagram illustrating another exemplary system for identifying persons having common contacts. As shown in FIG. 2, the contact clearing house 100 can include a contact list 150 corresponding to person 210 and a contact list 160 corresponding to person 220. The contact clearing house 100 can be remotely located from a room or building 200 containing participating persons 210 and 220, as well as other non-participating persons 230. In room 200, person 210 is shown as having PCD 110 and person 220 is shown as having PCD 130. Accordingly, PCDs 110 and 130 can include identifying information corresponding persons 210 and 220 respectively.

In operation, person 210 can set PCD 110 to send a locally transmitted message 215 containing the identity of person 210. For example, PCD 110 can be set to continuously transmit message 215 using an infrared communications port of PCD 110. For example, a locally transmitted communication can be any communication from another portable computing device that originates within the general vicinity of the first portable computing device, such as within a room, a meeting place, or within communications range of an infrared port of a conventional portable computing device. Person 220 can set PCD 130 to transmit as well as receive transmissions from other PCDs such as PCD 110. Therefore, although message 215 was not specifically directed at PCD 130, PCD 130 can receive message 215 identifying person 210 as the user of PCD 110. Those skilled in the art will recognize that due to the nature of infrared communications, an infrared transmission can reflect off of particular surfaces. Accordingly, such infrared communications need not be line of sight.

In any case, upon receiving message 215, PCD 130 can send a non-local wireless message 225 to the contact clearing house 100. The message 225 can identify person 210 and person 220. Notably, PCD 130 can receive local messages from more than one PCD. If so, then the communication 225 can identify each additional owner of such a sending PCD.

The contact clearing house 100 can receive the message 225 and search the contact lists corresponding to each person identified in message 225 for common contacts. For example, having identified person 210 and person 220, each person's corresponding contact list, contact lists 150 and 160 respectively, can be compared. As shown in FIG. 2, contact lists 150 and 160 include a common contact named “Jane”. Notably, the contact clearing house 100 further can ensure that the person named Jane included in contact lists 150 and 160 is the same person. For example, the contact clearing house can compare additional features related to each Jane entry such as the contact category, i.e., business or personal, address information, e-mail address, telephone numbers, and the like.

Having identified a common contact, the contact clearing house 100 can send a message to one or both PCDs 110 and 120. More specifically, a non-local wireless message 240 can be sent to PCD 130 and a similar message 245 can be sent to PCD 110. The messages 240 and 245 can include the identify of the common contact, a visual identifier, and optionally the identity of each party having a common contact. For example, the message 240 can include the identity of person 210 as well as the identity of the common contact named “Jane”. Additionally, the message 240 can include a representation of a visual identifier such as text or a pattern. Notably, the visual identifiers can be preset patterns stored in PCDs 110 and 130 or within the displays. In that case, the message 240 can include an indication of which visual identifier to display.

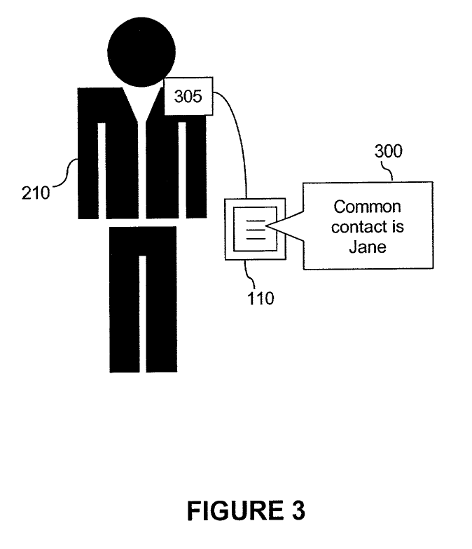

FIG. 3 is a schematic diagram illustrating exemplary components which can be used with embodiments of the system disclosed herein. As shown in FIG. 3, person 210 can be equipped with PCD 110 and a display device 305. Accordingly, upon receiving message 245, the PCD 110 can provide a notification 300 to person 210 that another person has a common contact. For example, the PCD 110 can display a message such as “Common contact is Jane”. As mentioned, PCD 110 further can provide the identity of the person having the common contact, for example person 220. In that case, the notification can read, for example, “Joe Smith is present and knows Jane” wherein “Joe Smith” can be person 220. Although PCD 110 is shown providing visual notification to person 210, PCD 110 can provide any of a variety of notifications. For instance, PCD 110 can vibrate or provide audio notification.

In addition to providing the user with notification, the PCD 110 can provide the display device 305 with a visual identifier that can be displayed. Notably, the person having a common contact also can be equipped with a display device such that the same visual identifier can be displayed on each display. For example, the common visual identifier can be an “X”, a “Y”, or the like, such that a person can look for others with displays displaying the same symbol as that person, whether an “X”, a “Y”, etc. Persons having the same identifiers have one or more common contacts. Accordingly, each person, for example person 210 and 220, can mutually, visually identify one another. Other embodiments of the invention can include displaying on display 305 the identity of the common contact as well as the identities of the persons having the common contact.

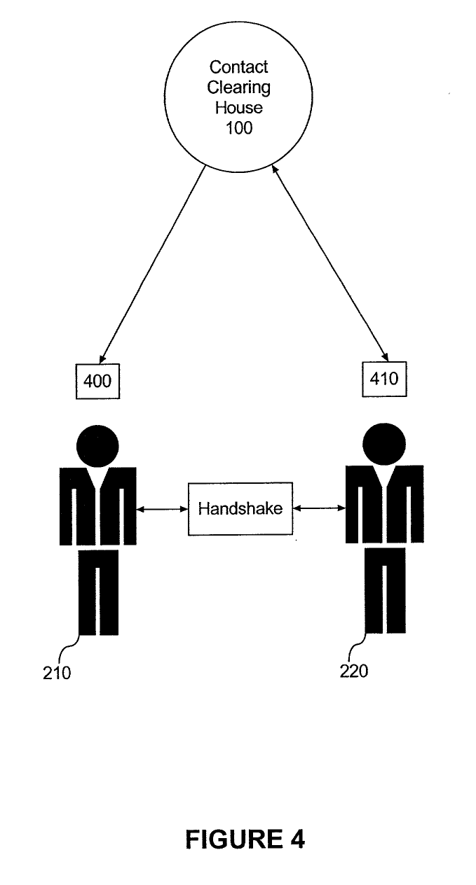

FIG. 4 is a schematic diagram illustrating another exemplary embodiment of a system for identifying persons having common contacts. As shown in FIG. 4, person 210 can be equipped with PCD 400 and person 220 can be equipped with PCD 410. The contact clearing house 100 also can be provided. In this embodiment of the invention, person 210 and person 220 can exchange identifying messages through physical contact such as a handshake. This method of communication can be referred to as near-field intrabody communication. Accordingly, PCDs 400 and 410 can perform such communication. Further information regarding near-field intra-body communication can be found in “Personal Area Networks: Near-Field intrabody communication”, by T. G. Zimmerman in IBM Systems Journal, vol. 35, nos. 3 & 4, p. 609 (1996), which is incorporated herein by reference.

Similar to the previous embodiments, PCD 410 can receive a message originating from PCD 400 through a handshake with person 210 and continuing through person 220. The message can identify person 210. PCD 410 can send a non-local wireless message to the contact clearing house 100. The message can identify person 210 and person 220 to the contact clearing house 100. The contact clearing house 100 subsequently can compare stored contact lists corresponding to person 210 and person 220 to determine whether those persons have any contacts in common. If so, the contact clearing house can send a non-local wireless message to PCD 400 and PCD 410 as previously mentioned.

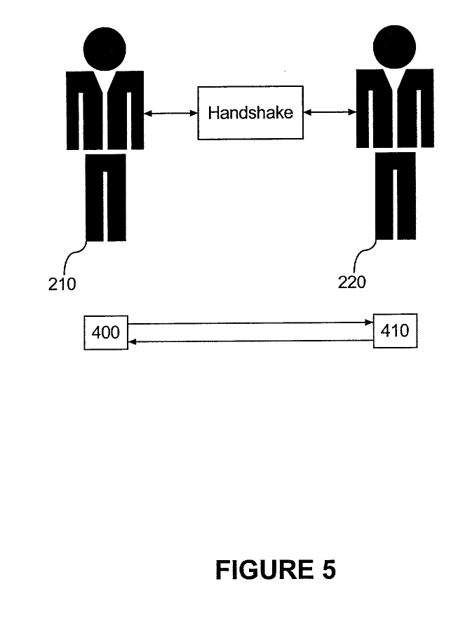

FIG. 5 is a schematic diagram illustrating another exemplary system for identifying persons having common contacts. In this embodiment, PCDs 400 and 410 can include contact information corresponding to persons 210 and 220 respectively. Additionally, each PCD can include a computer program for sending and receiving another person's contact information as well as for comparing that information to locally stored contact information. Accordingly, in the embodiment of FIG. 5, no contact clearing house is needed as each PCD 400 and 410 can send and receive contact information using near-field intrabody communications. Once information is transferred, any received contact information can be compared to contact information locally. If common contacts are found, PCDs 400 and 410 can provide notification to persons 210 and 220 respectively. Still, persons 210 and 220 can be equipped with displays as previously mentioned.

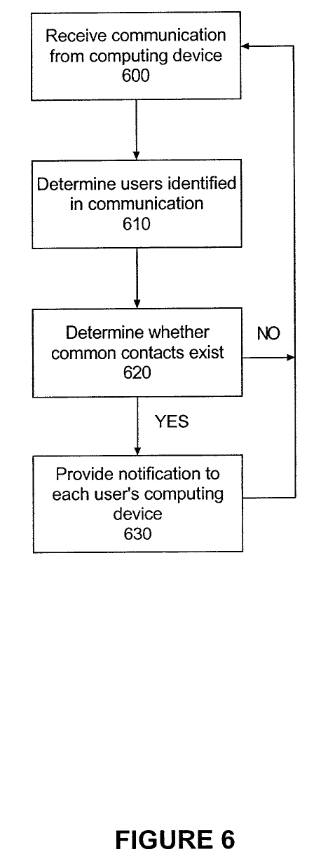

FIG. 6 is a flow chart illustrating an exemplary method of identifying persons having common contacts. The method can begin in step 600 in a state wherein a sender having set his or her PCD to send an identifying message has sent a message to a recipient's PCD which has been set to receive. The recipient's PCD can process the received message to determine the identity of the sender. Accordingly, the recipient's PCD can include the identity of the sender and recipient within a non-local wireless message to a contact clearing house. Accordingly, in step 600, the message can be received by the contact clearing house.

In step 610, the received message can be processed to determine the identity of the persons listed in the message. In this case, the identities of the sender and the recipient can be determined. In step 620, the contact lists corresponding to the sender and the recipient can be compared to determine whether any common contacts exist. If not, the method can loop back to step 600 where the method can be repeated as necessary for subsequently received messages. If one or more common contacts exist, however, in step 630, the contact clearing house can send a non-local wireless message to the sender's PCD and the recipient's PCD indicating that another person within the local area has a common contact.

It should be appreciated by those skilled in the art, that particular contacts of a person's contact list can be marked private or non-public. Thus, a contact marked as private or non-public would not be compared to another's contact list in the determination of common contacts. This can be the case whether the contact lists are compared within the PCDs or within the contact clearing house. Still, users can be provided with control over which contacts, if any, are included within the contact clearing house contact lists.

In another embodiment of the present invention, the PCD can notify the user of another person having a common contact and provide the user with a choice whether to enable the display device. Accordingly, the user can selectively enable the display device or set the display device to automatically display the visual identifier.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof; and, accordingly, reference should be had to the following claims, rather than to the foregoing specification, as indicating the scope of the invention.

What is claimed is:

1. A method for common contact identification comprising:
receiving in a first portable computing device corresponding to a first user a local communication from a second portable computing device corresponding to a second user, wherein said local communication identifies said second user;
receiving at a central receiving station a non-local wireless communication from said first portable computing device identifying at least said first and said second user;
accessing a data store comprising contact information corresponding to said first user and said second user to determine whether said first user and said second user have at least one common contact; and
if at least one common contact is determined, sending at least one subsequent non-local wireless communication to said first and second portable computing devices including an identifier common to said first and second users and corresponding to said at least one common contact.

2. The method of claim 1, wherein said at least one subsequent non-local wireless communication identifies said first and second users.

3. The method of claim 1, wherein said at least one subsequent non-local wireless communication identifies said at least one common contact.

4. The method of claim 1, wherein said second portable computing device provides notification to said second user that another user has at least one common contact.

5. The method of claim 1, wherein said first portable computing device provides notification to said first user that another user has at least one common contact.

6. The method of claim 1, wherein said identifier is a visual identifier to be provided to a display unit.

7. The method of claim 1, wherein said local communication is a wireless communication.

8. The method of claim 1, wherein said local communication is a wireless infrared communication.

9. The method of claim 1, wherein said local communication is a near-field intrabody communication.

10. A method for common contact identification using a portable computing device comprising:
at a first portable computing device, receiving a local communication from a second portable computing device, said local communication identifying a second user corresponding to said second portable computing device;
sending a non-local wireless communication from said first portable computing device to a receiving station, said non-local wireless communication identifying said second user and a first user corresponding to said first portable computing device; and
receiving a non-local wireless communication from said receiving station, said non-local wireless communication including a contact common to said first user and said second user and an identifier common to both said users.

11. The method of claim 10, further comprising:
notifying said first user that another user has been identified as having a common contact.

12. The method of claim 10, wherein said notification provides the identity of said second user.

13. The method of claim 10, further comprising:
specifying said identifier to a display.

14. The method of claim 10, wherein said local communication is a wireless communication.

15. The method of claim 10, wherein said local communication is a wireless infrared communication.

16. The method of claim 10, wherein said local communication is a near-field intrabody communication.

17. A method for common contact identification using a portable computing device comprising:
receiving in a first portable computing device a near-field intrabody communication from a second portable computing device, said communication including contact information from said second portable computing device;
comparing said contact information from said second portable computing device to contact information within said first portable computing device to determine whether one or more common contacts exist; and
providing a notification if one or more common contacts exist.

18. The method of claim 17, wherein said notification is displaying a visual identifier.

19. The method of claim 17, wherein said notification is an audible sound.

20. A method for common contact identification using a portable computing device comprising:
receiving in a first portable computing device a local communication from a second portable computing device, said communication including contact information from said second portable computing device;
comparing said contact information from said second portable computing device to contact information within said first portable computing device to determine whether one or more common contacts exist; and
providing a notification if one or more common contacts exist.

21. The method of claim 20, wherein said notification is displaying a visual identifier.

22. The method of claim 20, wherein said notification is an audible sound.

23. The method of claim 20, wherein said local communication is a wireless communication.

24. The method of claim 20, wherein said local communication is a wireless infrared communication.

25. A machine-readable storage, having stored thereon a computer program having a plurality of code sections executable by a machine for causing the machine to perform the steps of:
receiving in a first portable computing device corresponding to a first user a local communication from a second portable computing device corresponding to a second user, wherein said local communication identifies said second user;
receiving at a central receiving station a non-local wireless communication from said first portable computing device identifying at least said first and said second user;
accessing a data store comprising contact information corresponding to said first user and said second user to determine whether said first user and said second user have at least one common contact; and
if at least one common contact is determined, sending at least one subsequent non-local wireless communication to said first and second portable computing devices including an identifier common to said first and second users and corresponding to said at least one common contact.

26. The machine-readable storage of claim 25, wherein said at least one subsequent non-local wireless communication identifies said first and second users.

27. The machine-readable storage of claim 25, wherein said at least one subsequent non-local wireless communication identifies said at least one common contact.

28. The machine-readable storage of claim 25, wherein said second portable computing device provides notification to said second user that another user has at least one common contact.

29. The machine-readable storage of claim 25, wherein said first portable computing device provides notification to said first user that another user has at least one common contact.

30. The machine-readable storage of claim 25, wherein said identifier is a visual identifier to be provided to a display unit.

31. The machine-readable storage of claim 25, wherein said local communication is a wireless communication.

32. The machine-readable storage of claim 25, wherein said local communication is a wireless infrared communication.

33. The machine-readable storage of claim 25, wherein said local communication is a near-field intrabody communication.

34. A machine-readable storage, having stored thereon a computer program having a plurality of code sections executable by a machine for causing the machine to perform the steps of:
at a first portable computing device, receiving a local communication from a second portable computing device, said local communication identifying a second user corresponding to said second portable computing device;
sending a non-local wireless communication from said first portable computing device to a receiving station, said non-local wireless communication identifying said second user and a first user corresponding to said first portable computing device; and
receiving a non-local wireless communication from said receiving station, said non-local wireless communication including a contact common to said first user and said second user and an identifier common to both said users.

35. The machine-readable storage of claim 34, further comprising:
notifying said first user that another user has been identified as having a common contact.

36. The machine-readable storage of claim 34, wherein said notification provides the identity of said second user.

37. The machine-readable storage of claim 34, further comprising:
specifying said identifier to a display.

38. The machine-readable storage of claim 34, wherein said local communication is a wireless communication.

39. The machine-readable storage of claim 34, wherein said local communication is a wireless infrared communication.

40. The machine-readable storage of claim 34, wherein said local communication is a near-field intrabody communication.

41. A machine-readable storage, having stored thereon a computer program having a plurality of code sections executable by a machine for causing the machine to perform the steps of:
receiving in a first portable computing device a near-field intrabody communication from a second portable computing device, said communication including contact information from said second portable computing device;
comparing said contact information from said second portable computing device to contact information within said first portable computing device to determine whether one or more common contacts exist; and
providing a notification if one or more common contacts exist.

42. The machine-readable storage of claim 41, wherein said notification is displaying a visual identifier.

43. The machine-readable storage of claim 41, wherein said notification is an audible sound.

44. A machine-readable storage, having stored thereon a computer program having a plurality of code sections executable by a machine for causing the machine to perform the steps of:
receiving in a first portable computing device a local communication from a second portable computing device, said communication including contact information from said second portable computing device;
comparing said contact information from said second portable computing device to contact information within said first portable computing device to determine whether one or more common contacts exist; and
providing a notification if one or more common contacts exist.

45. The machine-readable storage of claim 44, wherein said notification is displaying a visual identifier.

46. The machine-readable storage of claim 44, wherein said notification is an audible sound.

47. The machine-readable storage of claim 44, wherein said local communication is a wireless communication.

48. The machine-readable storage of claim 44, wherein said local communication is a wireless infrared communication.
